(19) United States
(12) Patent Application Publication
(10) Pub. No.: US 2011/0161215 A1
(43) Pub. Date: Jun. 30, 2011

(54) Method and System for Tracking Billing Information

(76) Inventors: Christina Reed, Coppell, TX (US); Alec Bell, Dallas, TX (US); Pamela Brumfield, Plano, TX (US); Ling Chen, Allen, TX (US); Eric Dickerman, Alba, TX (US); George Harper, Garland, TX (US); Michael Harrington, Plano, TX (US); Kevin Horn, Carrollton, TX (US); Charles Ragona, Mesquite, TX (US); Jeffrey Heisroth, Richardson, TX (US)

(21) Appl. No.: 12/647,882

(22) Filed: Dec. 28, 2009

(51) Int. Cl. G06Q 30/00; G06Q 10/00; H04L 9/32

(52) U.S. Cl. 705/34; 705/30; 705/301; 709/203; 726/2; 709/207; 705/7.39

(57) ABSTRACT

Described herein are systems and methods for tracking, monitoring, projecting and reporting billing information. One embodiment is related to a computer readable storage medium including a set of instructions that are executable by a processor, the set of instructions being operable to receive billing data from at least one billing process, analyze changes in the at least one billing process, monitor the at least one billing process for an occurrence of time-based events, reconcile unique identifiers within the billing data to verify data integrity, generate a billing report based on the changes, the time-based events and data integrity, and audit the billing report for format errors.

### BACKGROUND

Bill tracking within a business or organization is the discipline of planning, organizing, and managing resources in order to receive payment from customers. Specifically, the process includes sending accounts to customers for goods or services, wherein the document used is referred to as an invoice. An invoice may be described as a commercial document issued by a service provider to a customer, indicating products, quantities, and pricing for products and/or services provided to the customer. Furthermore, an invoice may indicate the payment terms in which the customer shall pay the service provider. Accordingly, the invoice may be attached to the goods or forwarded separately. Within the telecommunication industry, the term billing is also used for systems and methods that collect information about telephone calls and other services that are going to be billed to the customer (i.e., the subscriber).

The primary focus of any bill tracking system, or billing system, is to streamline a business enterprise through recurring invoices, such as billing cycles. A secondary focus would be to optimize the collection and reporting of data related to the recurring billing cycles. A billing cycle may be described as a period between bills (i.e., invoices) for the products and/or services received, such as monthly or quarterly billing cycles.

With large volumes of bills to be processed, business enterprises may quickly become disorganized. The currently available corporate tools cannot support the level of granularity needed to effectively manage this work. There are inconsistencies in the manual process organization used to create billing information and collect payment. These inconsistencies result in increased paperwork and processing, late invoice generation, duplication of efforts, and an overall decrease in data accuracy. Accordingly, the inability to accurately track critical billing data creates a multitude of data integrity issues, such as insert/deletion anomalies, multi-user issues, data corruption, and individual field deadlocks. The end result of the inefficient bill tracking leads to inconsistent data and unfavorable business operations.

### SUMMARY OF THE INVENTION

Described herein are systems and methods for tracking, monitoring, projecting and reporting billing information. One embodiment of the disclosure of this application is related to a computer readable storage medium including a set of instructions that are executable by a processor, the set of instructions being operable to receive billing data from at least one billing process, analyze changes in the at least one billing process, monitor the at least one billing process for an occurrence of time-based events, reconcile unique identifiers within the billing data to verify data integrity, generate a billing report based on the changes, the time-based events and data integrity, and audit the billing report for format errors.

A further embodiment of the disclosure of this application is related to a bill tracking system. Specifically, a billing system including a receiving means receiving billing data from at least one billing process, an analyzing means analyzing changes in the at least one billing process, a monitoring means monitoring the at least one billing process for an occurrence of time-based events, and a reconciling means reconciling unique identifiers within the billing data to verify data integrity, a report generating means generating a billing report based on the changes, the time-based events and data integrity, and an auditing means auditing the billing report for format errors.

### BRIEF DESCRIPTION OF THE DRAWINGS

FIG. 1 shows an exemplary system for performing bill tracking and analysis across systems and departments according to an exemplary embodiment of the application.

FIG. 2 shows an exemplary screen view for entering login via a GUI of the billing tool according to an exemplary embodiment of the application.

FIG. 3 shows an exemplary screen view for securely authenticating a user via a GUI of the billing tool according to an exemplary embodiment of the application.

FIG. 4 shows an exemplary screen view for selecting an application from an application menu via a GUI of the billing tool according to an exemplary embodiment of the application.

FIGS. 5A-5E show exemplary screen views for requesting information for bill verification within a GUI of the billing tool according to an exemplary embodiment of the application.

FIG. 6 shows an exemplary screen view for listing open work requests within a GUI of the billing tool according to an exemplary embodiment of the application.

FIG. 7 shows an exemplary screen view listing open billing cycles of the billing tool according to an exemplary embodiment of the application.

FIG. 8 shows an exemplary screen displaying main cycle details of the billing tool according to an exemplary embodiment of the application.

FIG. 9 shows an exemplary screen of current escalations displayed on a GUI of the billing tool according to an exemplary embodiment of the application.

FIG. 10 shows an exemplary screen of bill count reconciliation on a GUI of the billing tool according to an exemplary embodiment of the application.

FIG. 11 shows an exemplary screen of usage assurance file verification on a GUI of the billing tool according to an exemplary embodiment of the application.

FIG. 12 shows an exemplary screen of switch control on a GUI of the billing tool according to an exemplary embodiment of the application.

FIG. 13 shows an exemplary screen of market daily status on a GUI of the billing tool according to an exemplary embodiment of the application.

FIG. 14 shows an exemplary screen of revenue analysis trending on a GUI of the billing tool according to an exemplary embodiment of the application.

FIG. 15 shows an exemplary screen shows an exemplary screen of balance report auditing on a GUI of the billing tool according to an exemplary embodiment of the application.

FIG. 16 shows an exemplary screen shows an exemplary screen of automated bill audit reporting on a GUI of the billing tool according to an exemplary embodiment of the application.

FIG. 17 shows an exemplary method for performing bill tracking and analysis across systems and departments according to an exemplary embodiment of the application.

### DETAILED DESCRIPTION

The exemplary embodiments of the application may be further understood with reference to the following description and the related appended drawings, wherein like elements are provided with the same reference numerals. The exemplary embodiments of the application are related to systems and methods for generating, tracking, and reporting billing information. Specifically, the exemplary embodiments are related to systems and methods for managing and monitoring the entire billing process of a business enterprise or organization. Furthermore, the exemplary embodiments may utilize a web-enable billing tool for centralized bill tracking, reporting, and analyzing all information related to the billing system and process, while providing a repository for any billing issues to be resolved in a timely manner.

As will be described in greater details below, the billing process may include any number of steps, such as the collection of billing data, print and mailing of the bills to customers, generating billing reports for organizational executives, etc. It should be noted that the exemplary billing tool may be achieved through the reuse of readily available data augmented by user input.

As will be described in examples below, data may be input into the bill management tool, or “billing tool”, by a user via a user interface. In addition or alternatively, data may be received and imported into the billing tool from other systems (e.g., time keeper systems, first and/or third-party billing systems, etc.) or may be calculated by the billing tool based on data previously entered into the billing tool. Once this data is collected and retained by the billing tool, the data may be reused across multiple views or processes carried out by the billing tool. This reuse of data ensures consistency of data between systems and organizations within the business enterprise.

According to the exemplary embodiments of the application, the exemplary billing tool may provide managers with the ability to manage and monitor the billing process at a more meaningful and useful level of detail, while also helping to facilitate some manual (e.g., labor-intensive) activities. Specifically, the billing tool may be described as an evolving application having the flexibility to grow with, and be customized to fit, any business needs, both current and future. In addition, executives may benefit as well by having better insight into the payment collection process, as well as any invoices that may be falling behind schedule. Thus, the exemplary tool may allow the personnel of the enterprise to more effectively achieve their goals.

The exemplary billing tool may allow users, such as project managers, to efficiently and effectively track critical events during a billing cycle, while providing notifications of any delays and/or escalated issues during the process. The exemplary billing tool provides for both automation and consistency in creating invoices and billing reports. As will be described in greater detail below, the exemplary billing tool allows for creating a collection of reports for efficient auditing and reviewing of billing data. In addition, the exemplary reports from the billing tool may serve as a central repository for tracking the billing process for all markets and cycles within the business enterprise, in order to ensure accurate and timely bill creation. Thus, the exemplary billing tool is capable of incorporating invoice generation and analysis at a very granular level (e.g., at the system level).

It should be noted that the exemplary billing tool may also provide combined horizontal and vertical detailed views of billing cycles and/or markets. When a billing cycle is tracked and viewable horizontally, a user (e.g., a manager) may see all of the data across systems, resources, and managers. When a billing cycle is tracked and viewable vertically, the user may see all of the data from a system-specific view that shows the status of only that particular billing cycle or market. Accordingly, the exemplary embodiments described herein may provide such horizontal and vertical views of bill tracking at a very detailed and granular level, such as at the system level.

The exemplary billing tool solves any conventional problems and shortcomings in bill generation and bill tracking. For instance, the exemplary management tool may provide a centralized reports and bill cycle information, may reduce billing times and late mailings, and may reduce paperwork and email associated with manual bill tracking. In addition, the billing tool may increase bill cycle accuracy by providing reconciliation tools and furnish access to live accurate statistics. Furthermore, the exemplary embodiment of the billing tool may solve these problems by using a highly efficient issue-tracking feature that proactively identifies each issue of a billing cycle, designating a issue status (e.g., medium, high, critical, etc.), and tracks each issue until completion of its respective cycle. The billing tool may also provide continuous, real-time fault management alert for any developing or outstanding critical issues and/or resources.

As discussed above, the exemplary embodiments will be described with reference to a web-based billing tool. Those skilled in the art will understand that the exemplary embodiments described herein may be implemented in any type of business operation, whether it is in the field of telecommunications, or otherwise. As will be described in greater detail below, regardless of the systems used, and regardless of which process a business uses, the portability and flexibility of the exemplary billing tool may allow for enterprise management and executives to track, report, and analyze all information related to the enterprise billing system.

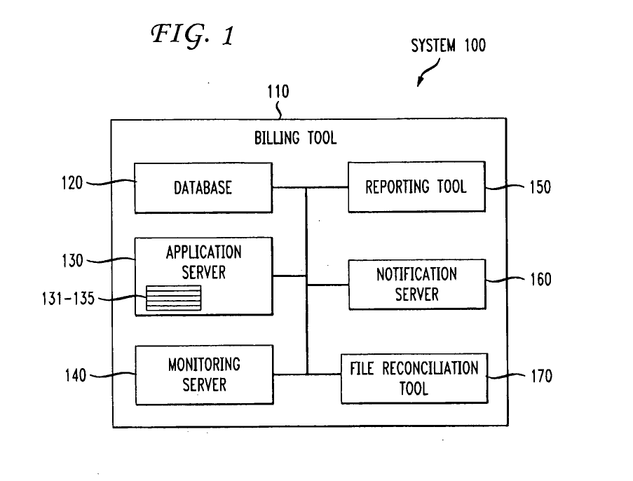

FIG. 1 shows an exemplary system 100 for performing bill tracking and analysis across systems and departments. The system may include a billing tool 110 for consolidating any data tracked by separate billing cycles in order to provide a user with a single overall, global view of this data. This billing tool 110 may include multiple components, such as a database 120, an application server 130, a monitoring server 140, a reporting server 150, a notification server 160, and a file reconciliation tool 170. Each of these components will be described in greater detail below. It should be noted that the billing tool 110 is not limited to a particular set of included components, and may include any number of components, either more or less than those illustrated in FIG. 1. Furthermore, each of these components of the system 100 may reside on a single component, or alternatively, on any number of computers within the billing system 100.

According to the exemplary embodiments of the system 100, the billing tool 110 may be a web-based piece of software (e.g., such as one having an Oracle RDBMS back end). The system and functions of the billing tool 110 may be implanted into a set of instructions that are executable by a processor of a computer, wherein the set of instructions may be stored on a computer-readable storage device, such as a memory. In addition, this web-based software may reuse existing data to ensure consistency of data between multiple systems and organizations, and may allow users to create billing reports that are meaningful to all different levels of management. Accordingly, the billing tool 110 may provide users with a global production view of all billing information through a single web interface. For instances, this web interface may be developed in Java and TCL scripting languages, and managed with software content management systems such as Vignette and Weblogic. The billing tool 110 may include a customizable rules-based engine that allows for automatic data retrieval. This rules-based engine may automate several tasks, such as, synchronous and asynchronous acquisition of billing data, monitoring of time based application-specific events, fault management of mediation systems, and escalation and notification of alerts. Furthermore, the billing tool 110 may utilize automatic PERL and SQL applications for tasks such as, but not limited to, reporting data collection, analyzing statistical trends, reporting exceptions, etc.

The exemplary system 100 may include a billing tool database 120, wherein any actions taken by a user on any screen within the billing tool 110 may be saved in the billing tool database 120. The data stored in the billing tool database 120 may include billing cycle information (e.g., cycle name and identification number, milestone dates, cycle status, escalation dates, completion dates, etc.), as well as available billing applications (e.g., scheduling data, bill handling data, reporting data, quality assurance data, etc.) Furthermore, the billing tool database 120 may include a log file to track any changes made to the data (e.g., a screen number and field name/number that was modified, a field's before and after value, and the date & time when the modification was made). Accordingly, the log file may track information for auditing and compliance purposes. Thus, the user input may be automatically saved at the field-level in order to minimize any data loss and to provide other users with instant (e.g., “real-time”) updates.

As noted above, the billing tool 110 may further include an application server 130. The application server 130 may have access to a plurality of applications 131-135, wherein each of the applications 131-135 may serve various functions of the billing tool 110, such as automating and centralizing the billing cycle. The applications 131-135 may allow the billing tool 110 to interface with any first or third-party vendors (e.g., print vendors, mailing vendors, billing vendors, etc.), and track the billing process to and from these parties. Furthermore, using any number of applications 131-135, the billing tool 110 may initiate the monitoring of any number of billing cycles. In addition, the number and utility of these applications 131-135 may be fully customizable and updated to allow for group creation and assignment as workload is increased. The various applications 131-135 may allow for managing billing schedules, billing reporting, error handling, as well as any number of business operation functions.

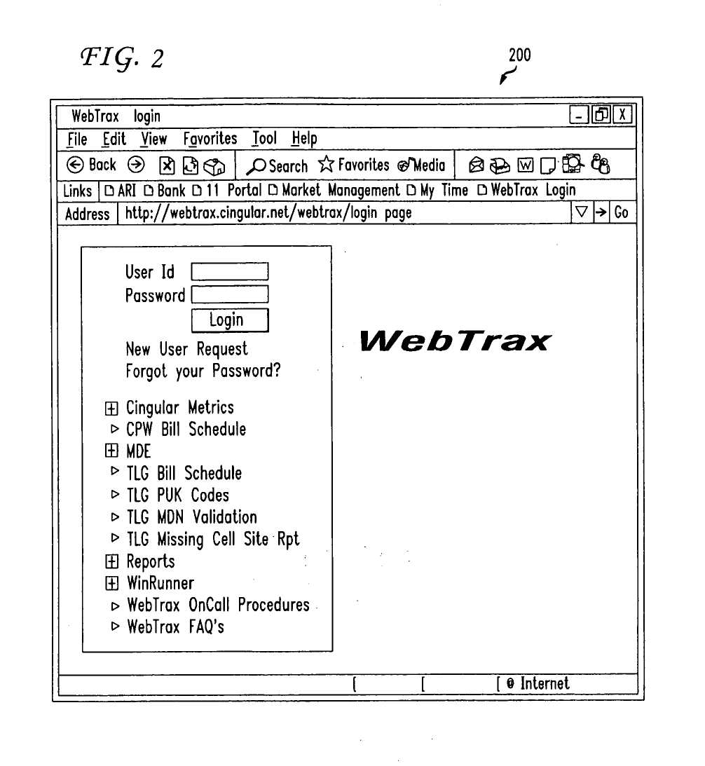

According to the exemplary embodiments of the billing tool 110, The applications 131-135 may include a verification system (e.g., a login screen), wherein the user may identify him or her self (e.g., enter a user name, employee number, etc.) and the application server 130 may adjust the menu of applications 131-135 according to the user's access level. The billing tool 110 may adjust the available other features (e.g., access to executive reports) based on the access level of the user. FIG. 2 shows an exemplary screen 200 for entering login via a GUI of the billing tool 110.

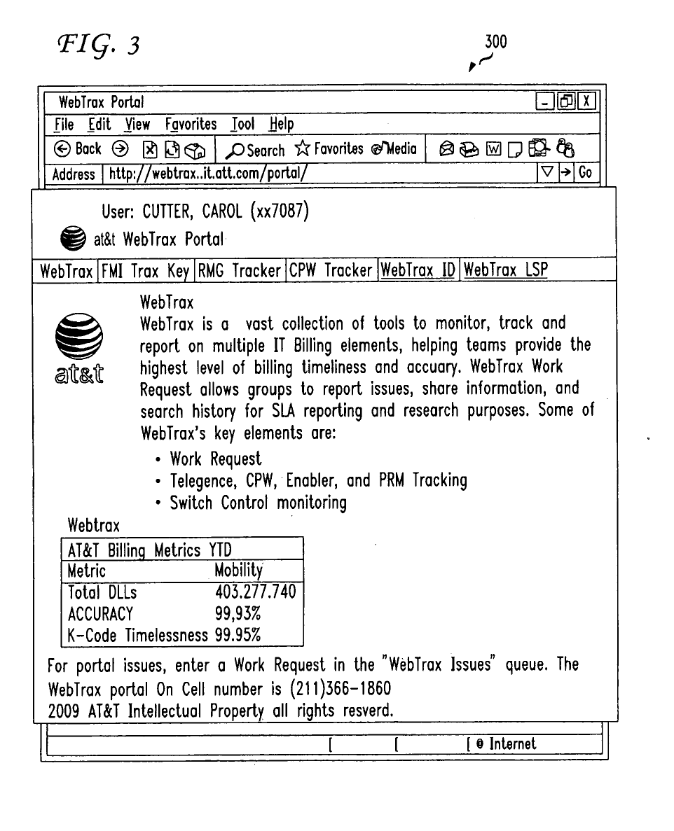

FIG. 3 shows an exemplary screen view 300 for securely authenticating a user via a GUI of the billing tool 110 according to an exemplary embodiment of the application. Specifically, the screen view 300 illustrated the portal functionality of the billing tool 110. The portal may provide users of the billing tool 110 with global login functionalities that securely authenticates users while providing a single entry to multiple applications of the billing system 110. In addition, the exemplary portal may provide the ability to create system-wide messages. Furthermore, the exemplary portal may provide user-specific authentication for each separate application. In other words, once a user is logged into the billing tool 110, this user may not have access to all of the applications. Therefore, the portal may provide the user with selective access to various applications based on a security level (e.g., clearance level) of the user. Also, the portal may also provide dashboard details for applications that each of the users have access to.

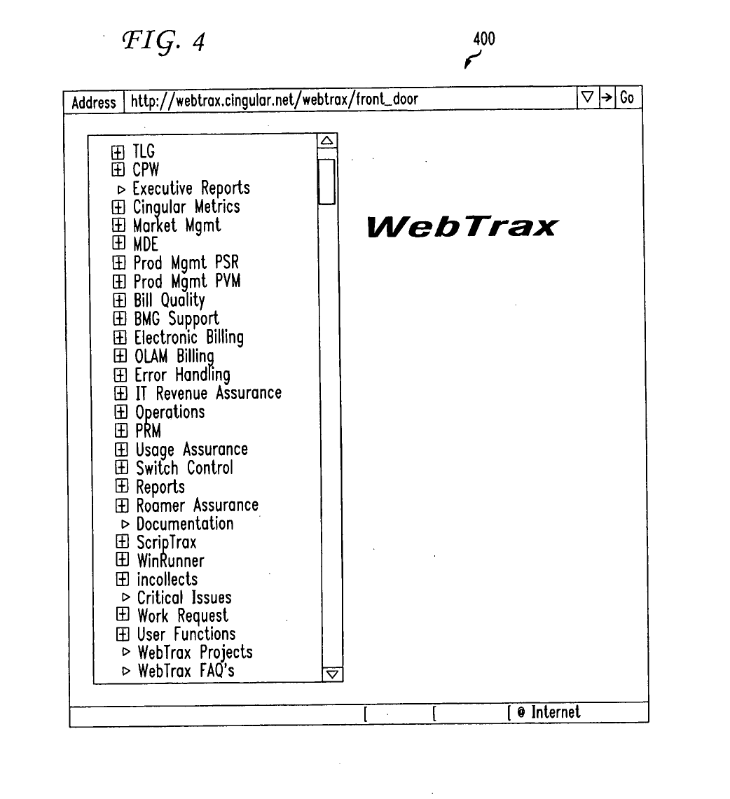

The application server 130 may display all available applications 131-135 on the web-based interface of the tool 110 (e.g., a graphical user interface (“GUI”) of a company intranet). Specifically, a GUI may display a menu of available applications 131-135. The available applications 131-135 listed within the menu may be based on an access level assigned to each particular users, or group of users (e.g., an administrative role, an executive role, etc.). FIG. 4 shows an exemplary screen view 400 for selecting an application from an application menu via a GUI of the billing tool 110.

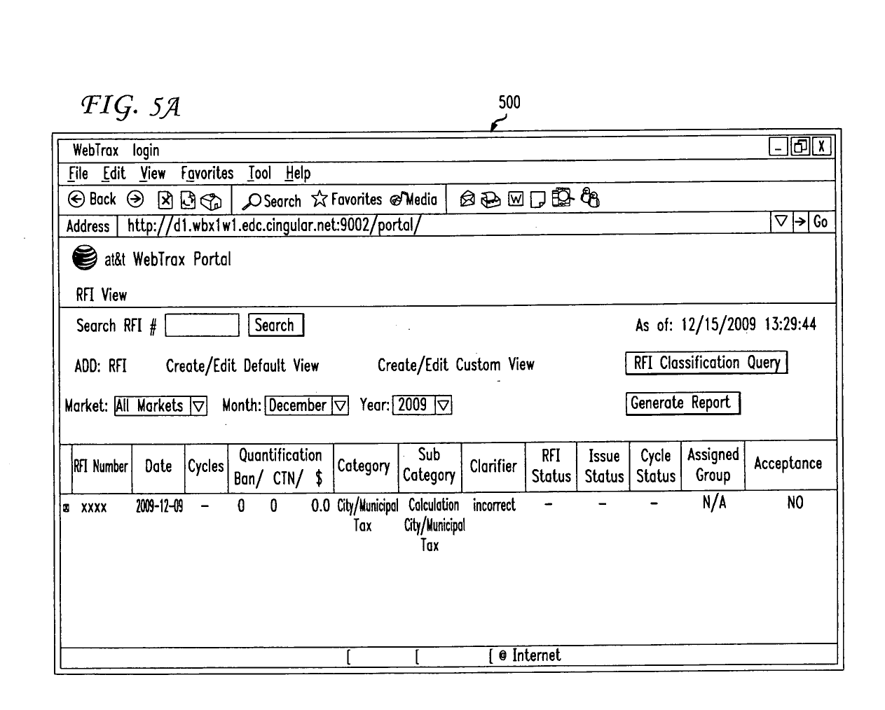

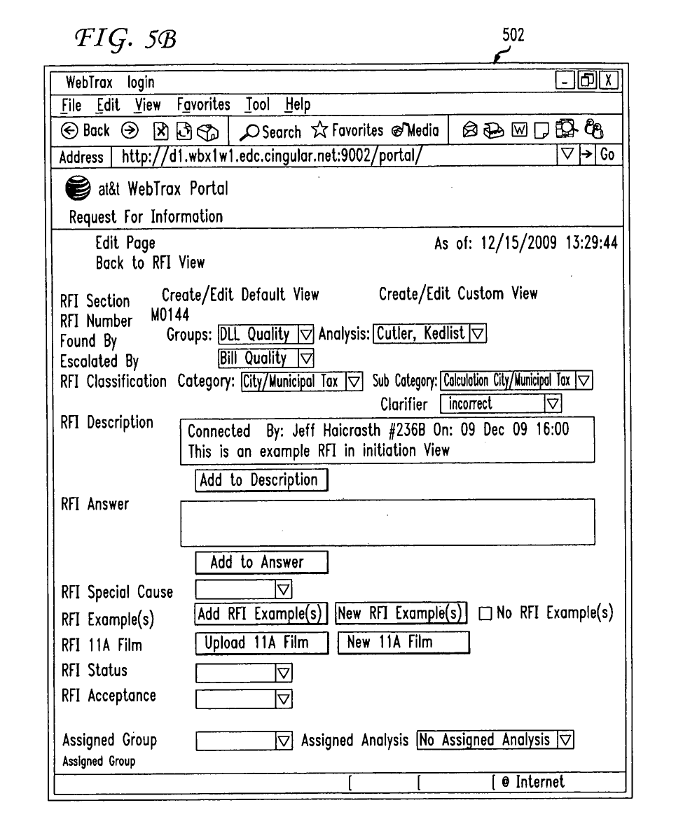

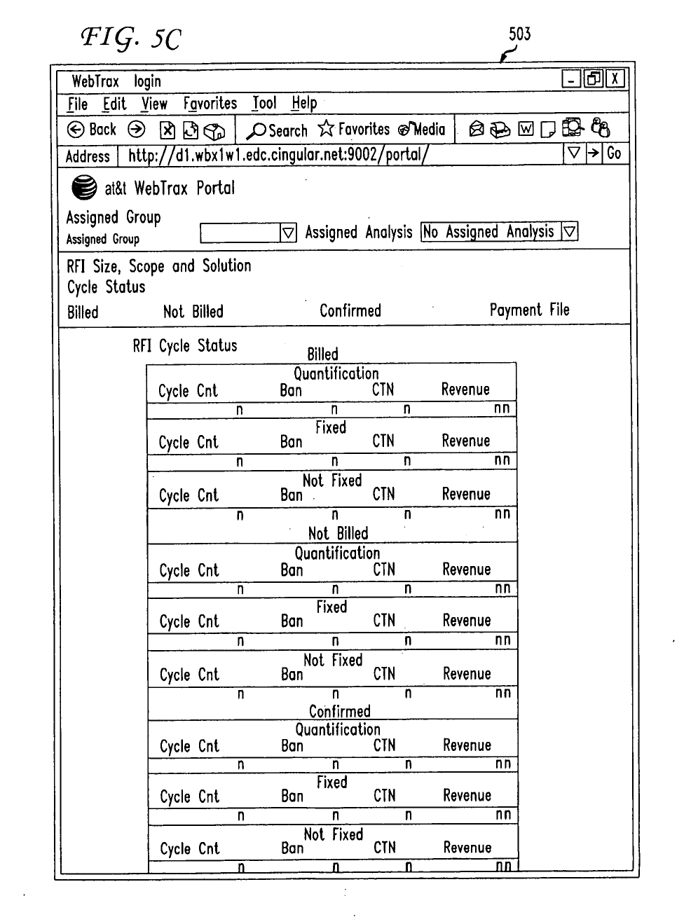

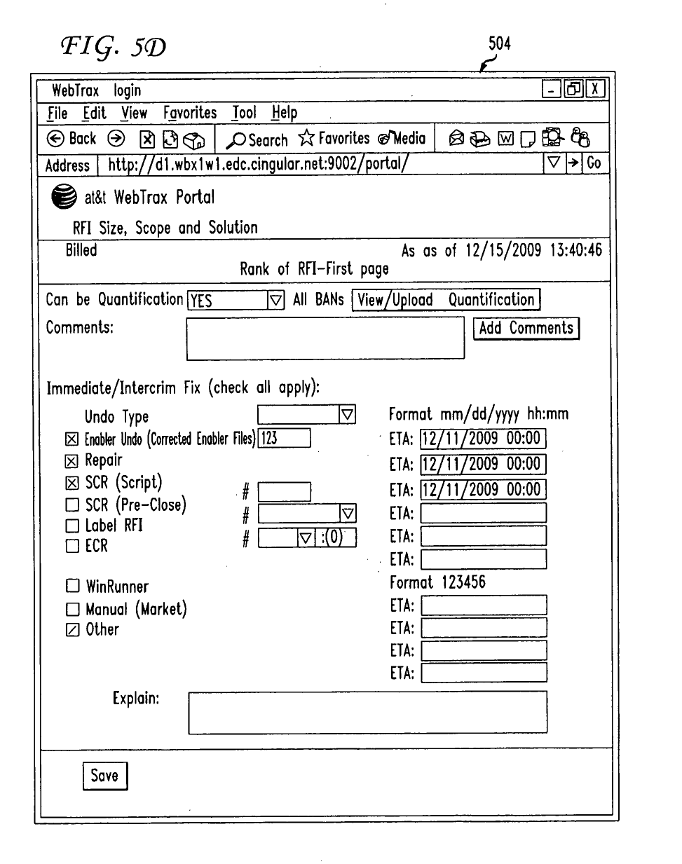

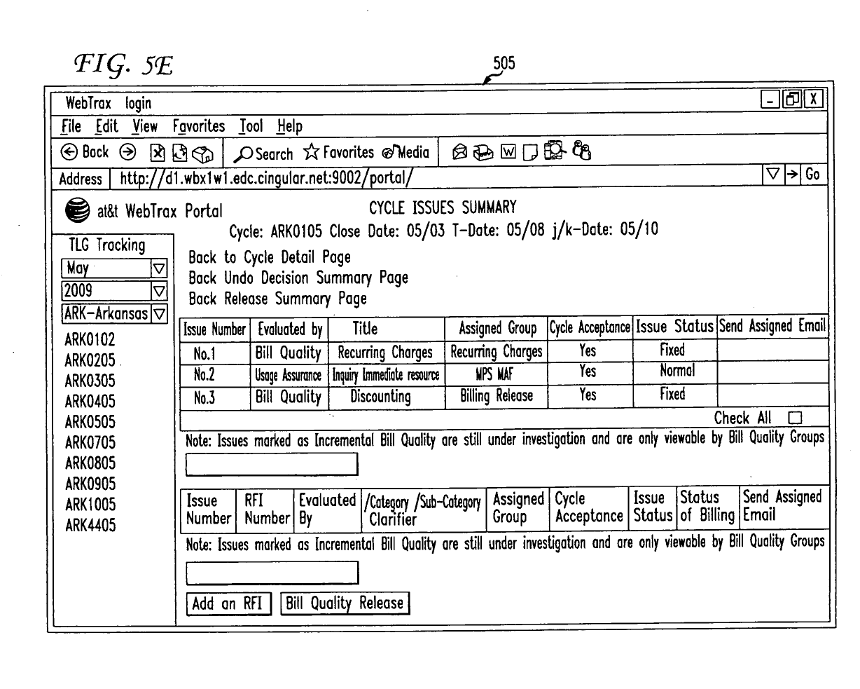

FIGS. 5A-5E show exemplary screen views 501-505 for requesting information for bill verification within a GUI of the billing tool 110 according to an exemplary embodiment of the application. This bill verification function may allow a user (e.g., a bill validation team member) to enter possible issues related to billing production for investigation. A bill verification report may store details and quantification for bill process review and auditing. As opposed to working only from the cycle-level, this bill verification process may work from the top level and drill down to the cycle-level, as full quantification is being investigated.

FIG. 5A shows an exemplary screen view 501 for summarizing a request for information (“RFI”) via a GUI of the billing tool 110. This screen 501 may allow the user to add an RFI entry, search existing RFI entries, generate a report of RFI entries, etc.

FIG. 5B shows an exemplary screen view 502 for summarizing a detailed RFI via a GUI of the billing tool 110. This screen 502 may provide detailed information such as RFI number, group identification, RFI classification, RFI description, RFI answers, etc.

FIG. 5C shows an exemplary screen view 503 for summarizing further details of an RFI via a GUI of the billing tool 110. This screen 503 may provide detailed information such as assigned group information, assigned analyst, RFI size/scope/solution information, RFI cycle status, etc.

FIG. 5D shows an exemplary screen view 504 for summarizing size, scope, and solution of an RFI via a GUI of the billing tool 110. This screen 504 may provide detailed information such as quantifications, solution details (e.g., immediate and/or interim fix options), estimated time of addressing/completion, detailed explanation, etc.

FIG. 5E shows an exemplary screen view 505 for summarizing cycle issue details via a GUI of the billing tool 110. This screen 505 may provide detailed information such as cycle description, close date, t-date, k-date, issue identification, issue status, cycle acceptance, assigned group, etc.

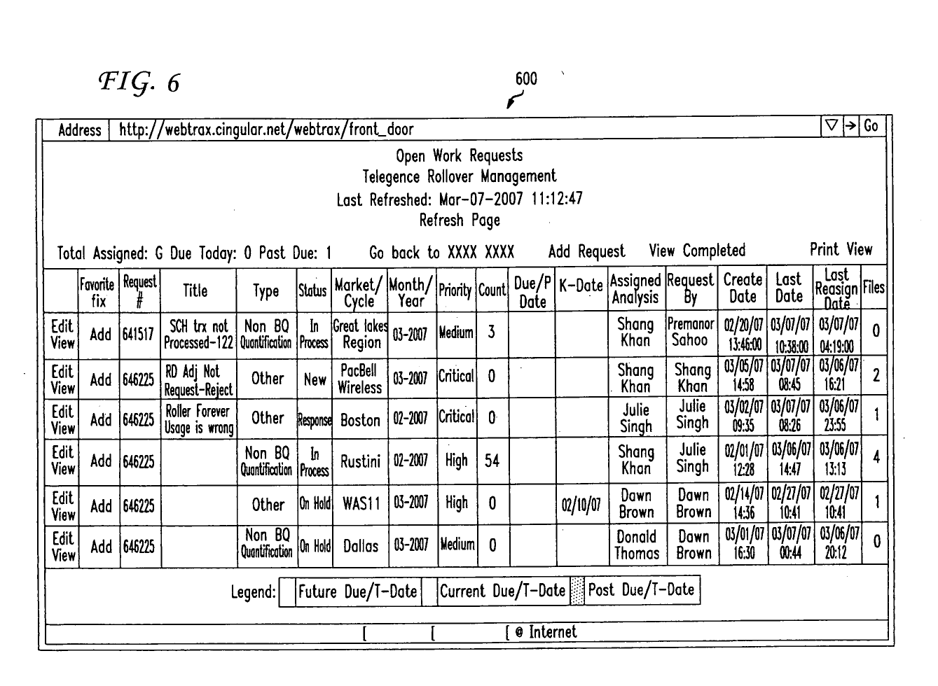

According to the exemplary embodiments of the billing tool 110, the application server 130 may allow for users to enter work requests directly into the billing tool 110. Specifically, the application server 130 may allow for any number of groups to request functions, provide information, or escalate outstanding issues. The work requests may be display in real-time on a GUI of the billing tool 110 and may be internally managed within each of the requesting groups. Once any work request is completed, a notification (e.g., an email, a page, an instant message, etc.) may be transmitted to the requesting user and others (e.g., group members) as specified. FIG. 6 shows an exemplary screen view 600 for listing open work requests within a GUI of the billing tool 110.

As noted above, the billing tool 110 may further include a monitoring server 140, or tracking server. Specifically, the monitoring server 140 may track, in real-time, various billing cycle data from mediation to bill mailing, message processing, data and voice processing, usage assurance, etc. Furthermore, the monitoring server 140 may track job statuses, issue statuses, switch control queues and processes, data collection for fault management, etc. The monitoring server 140 may also monitor system resources (e.g., file systems, processes, etc.) of the billing tool 110, as well as the associated applications 131-135. The monitoring server 140 may receive updates from billing system logs, reports, and databases for any number of billing cycles.

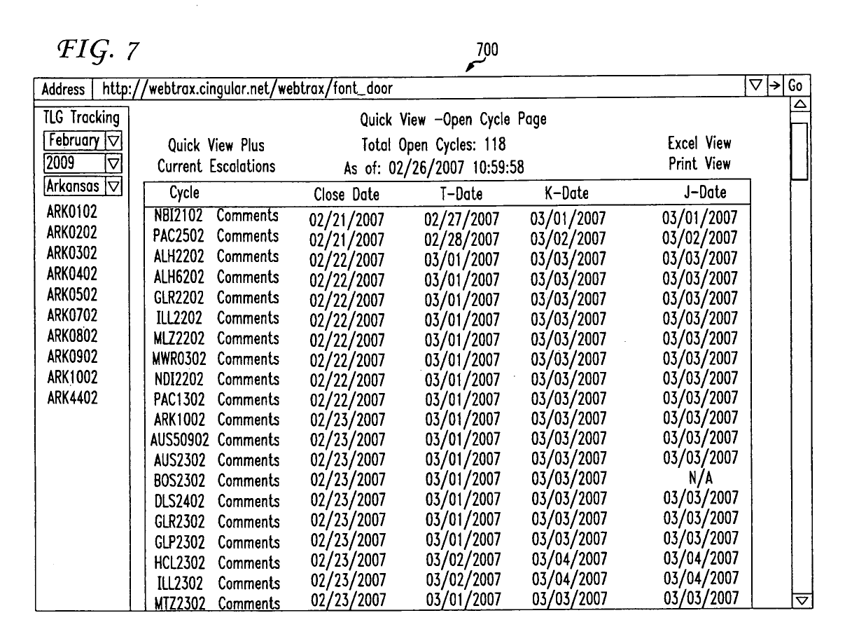

According to the exemplary embodiments of the billing tool 110, the monitoring server 140 allows for coordination and status tracking of issues/tasks between production groups. The monitoring server 140 may initiate and track work requests for various groups, and may provide analysis for current billing cycle reports. The monitoring server 140 may display an interactive list of open billing cycles on the web-based interface of the tool 110 (e.g., a GUI of a company intranet). Specifically, this GUI may display a quick view of all billing cycles with critical milestone dates, and allow the user to examine further details (e.g., “drill down” into cycle-level) of the tracking status and current escalations through links. FIG. 7 shows an exemplary screen view 700 a quick view list of open billing cycles of the billing tool 110.

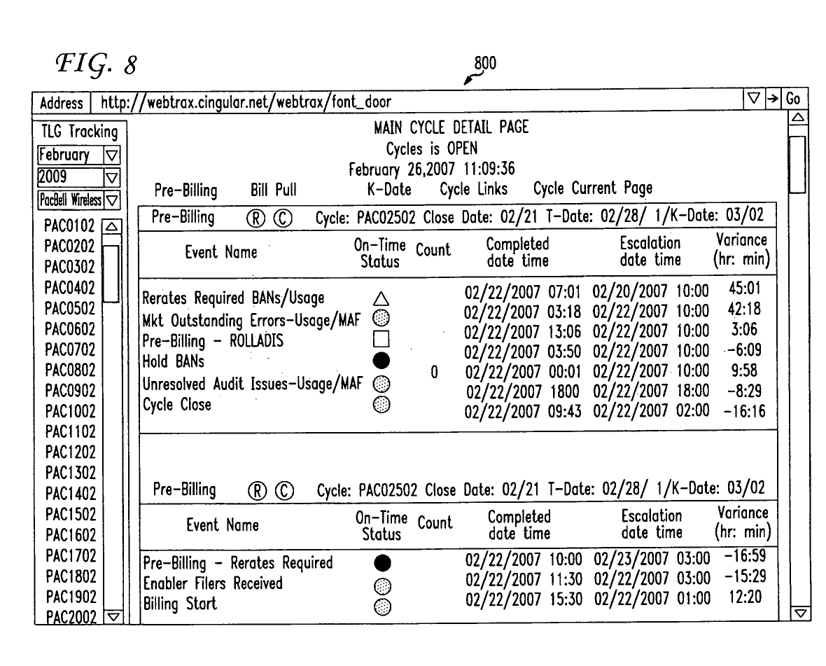

FIG. 8 shows an exemplary screen 800 of main cycle detail displayed on a GUI of the billing tool 110. This screen 800 may allow the user to select a cycle and display cycle details such as the event name, the on-time status, the completed time, the escalation time, any variance between time, etc. Thus, through the main cycle detail screen 800, the monitoring server 140 may track a job or process for any particular cycle running through billing. The monitoring server 140 may track events based on escalation date/time and completion date/time.

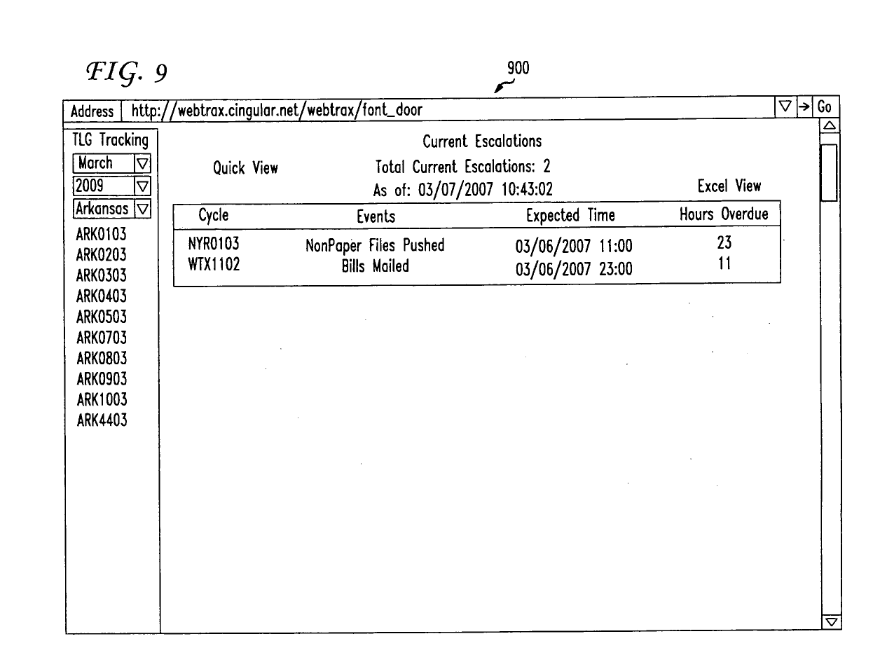

FIG. 9 shows an exemplary screen 900 of current escalations displayed on a GUI of the billing tool 110. This screen 900 may be a single view of all delayed, or otherwise escalated, processes within a billing cycle. Specifically, the current escalations screen may show the date/time in which each process is expected to be completed and the amount of time overdue (e.g., the number of hours, etc.) Accordingly, each of these processes may remain on display in screen 900, as escalated, until that process has been completed.

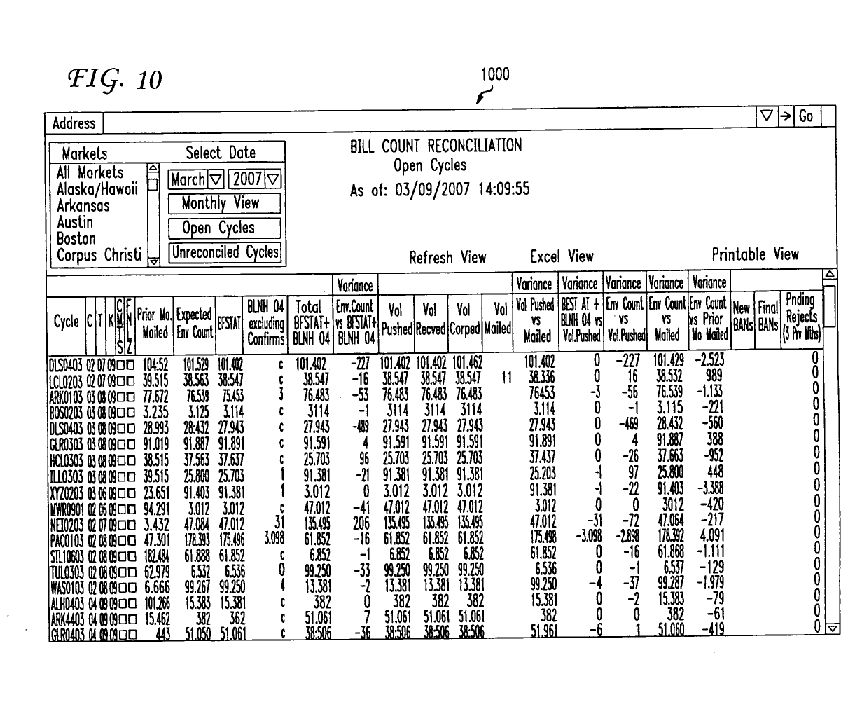

FIG. 10 shows an exemplary screen 1000 of bill count reconciliation on a GUI of the billing tool 110, as performed by the file reconciliation tool 170. Specifically, as will be noted below, the reconciliation tool 170 may reconcile unique identifiers within billing data to verify data integrity. The bill reconciliation screen 1000 may display a system-wide view of the critical cycle count for all currently running billing cycles. The user may select specific markets, cycle dates, viewing options, etc. The bill count reconciliation screen 1000 may allow for count variance validation and reconciliation for any of the open billing cycles.

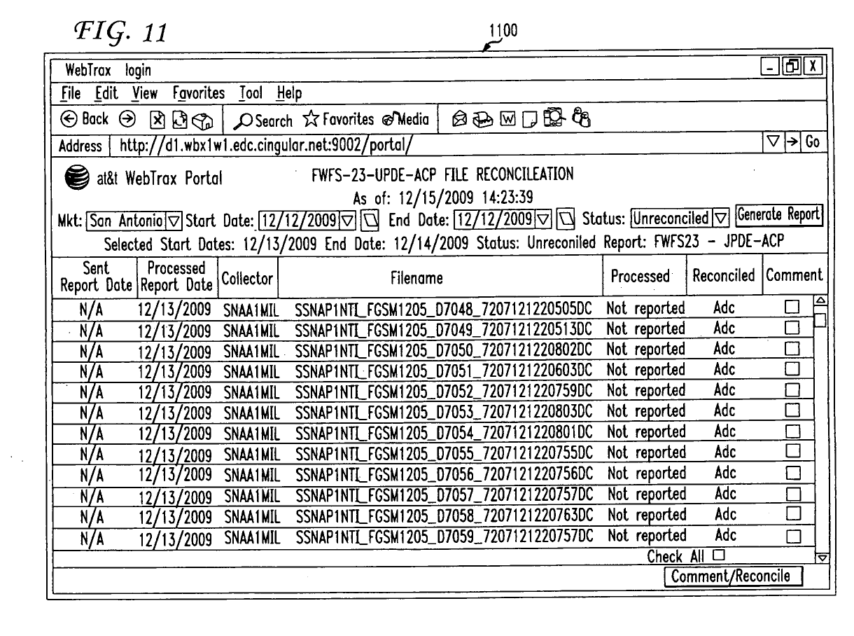

FIG. 11 shows an exemplary screen 1100 of usage assurance file verification on a GUI of the billing tool 110 according to an exemplary embodiment of the application. A usage assurance verification reporting, or the file reconciliation tool 170, may verify data integrity within the billing tool 110, thereby reducing and/or eliminating the risk of data loss. As files are transferred along multiple processes and applications, data loss may be possible. However, the file reconciliation tool 170 may accept multiple files along a progression, and then reconcile data points using unique identifiers. This process may ensure that there is no lost usage and/or revenue data. For example, System A may accept usage/revenue data and produces File A. System B may accept File A and produces File B. System C may accept File B and produces File C, etc. The reconciliation tool 170 may accept File A, File B, File C, etc. and store predetermined data in a database. Accordingly, any specified threshold anomalies may then be displayed for analyst review and analyst acceptance.

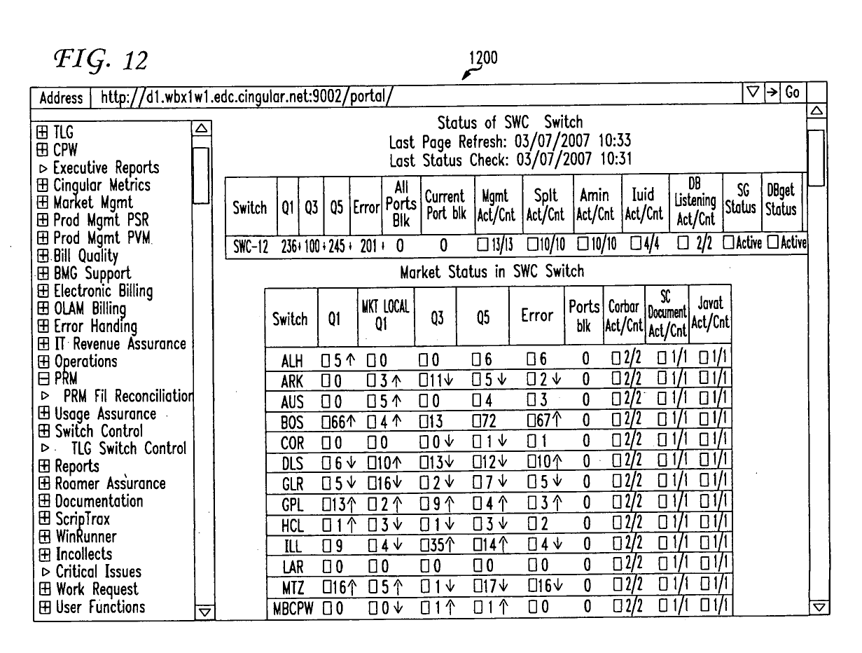

FIG. 12 shows an exemplary screen 1200 of switch control on a GUI of the billing tool 110. This screen 1200 may be produced by the monitoring server 140, and thus, provide the user with real-time status of key switch provisioning database metrics. Furthermore, the switch control screen 1200 may assist the user with proactive issue identification.

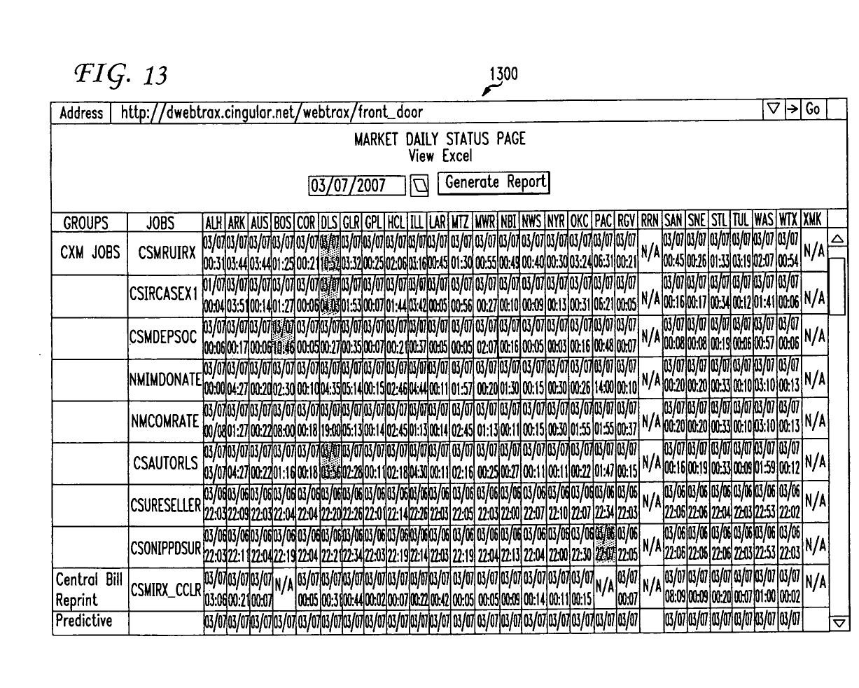

FIG. 13 shows an exemplary screen 1300 of market daily status on a GUI of the billing tool 110. This screen 1300 may be produced by the monitoring server 140, and thus, allow the user to track business critical daily-batch process. Specifically, the monitoring server 140 may monitor job logs based on completion date/time. The market daily status screen 1300 may display an indication of the current state of the job. For instance, jobs completed successfully on time may be gray, currently running jobs may be orange, jobs that have yet to run may be yellow, jobs that have failed to run may be red, etc. It should be noted that while this screen 1300 displays jobs on a daily status, similar screen may be utilized to track and display critical jobs on a weekly basis, monthly basis, etc.

As noted above, the billing tool 110 may further include a reporting server 150. Specifically, the reporting server 150 may serve as a repository of statistical data used in periodic (e.g., monthly, annually, etc.) executive reporting. Accordingly, the reporting server 150 may perform necessary calculations to create reports at each billing cycle at any level within the billing tool 110, such as the tracking level, the analysis level, the resource level, etc. The reporting server 150 may also provide reports on the time and accuracy of all billing data received and processed within the billing tool 110. Accordingly, the reporting server 150 may consolidate multiple reports without having to use a separate tool outside of the billing tool 110. Furthermore, the reporting server 150 may build reports in a compliant and consistent manner.

The reporting server 150 may analyze current and historic billing data and provide users with bill quality summaries for each billing cycle to assist in auditing the cycle. For instance, the reporting server 150 may audit any billing reports for format errors. Accordingly, the reporting server 150 may facilitate the auditing process for usage and revenue assurance organizations and may provide executive level reporting to all tiers of management.

An exemplary billing report may include information pertaining to any particular billing cycle, such as, but not limited to, a customer identifier (e.g., name, corporation, case number, etc.), billing description, billing type, billing activity, billing approval status, creation date, start date, employee identifier(s), etc. The workflow for creating billing reports may be an automated process built into the reporting server 150 in order to save the time of manual notifications while providing a streamlined and expedited production. Furthermore, the data utilized by the reporting server 150 may be more detailed and granular than any conventional management system. Accordingly, the reporting server 150 may allow users, such as executives, to observe and analyze their respective billing cycles and revenues in a horizontal and vertical manner, providing a complete picture of the current status of business operations.

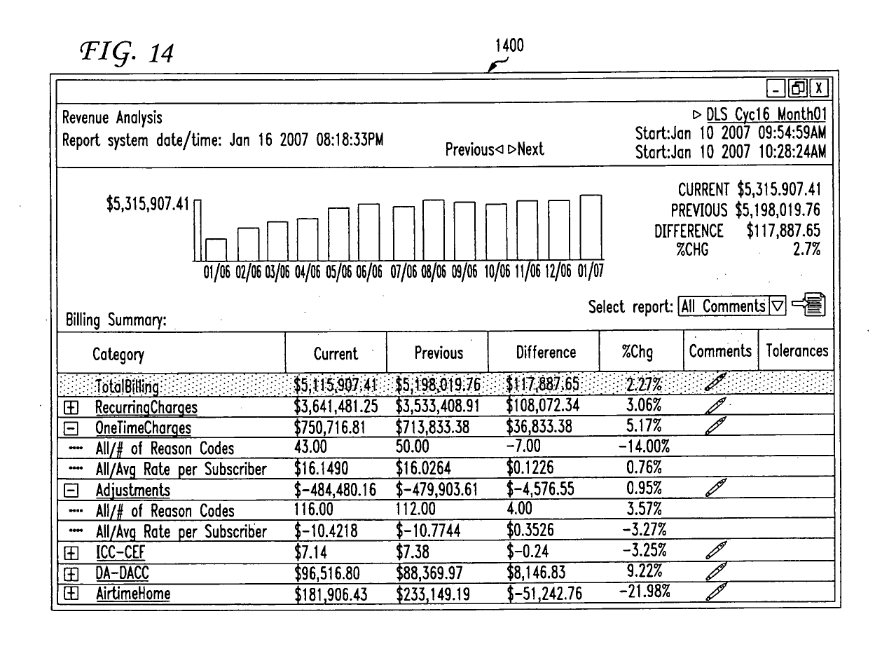

FIG. 14 shows an exemplary screen 1400 of revenue analysis trending on a GUI of the billing tool 110. This screen 1400 may be produced by the reporting server 150, and thus, provide the user with trending of bill cycle revenue data. Specifically, the reporting server 150 may generate a trending report to allow the users (e.g., an audit team) to manage tolerances and validate revenue fluctuations. The revenue analysis screen 1400 may display a billing summary for each cycle, including various categories of charges (e.g., recurring one-time charges, adjustments, etc.), and may report any changes in revenue for each category, as well as for the billing cycle.

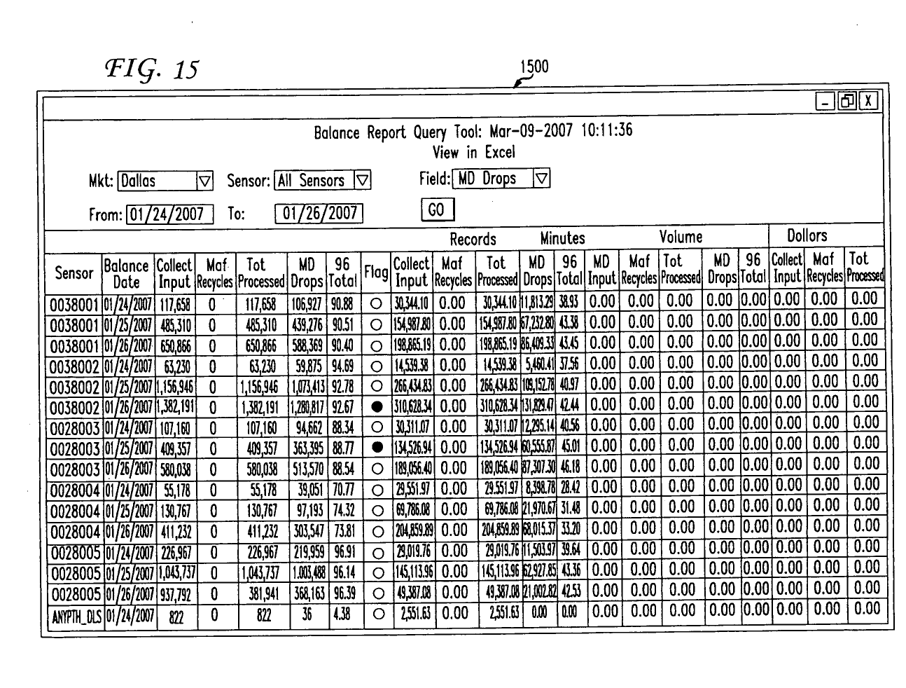

FIG. 15 shows an exemplary screen 1500 of balance report auditing on a GUI of the billing tool 110. This screen 1500 may be produced by the reporting server 150, and thus, provide the user with a daily switch-level representation of key metrics throughout the billing process. The reporting server 150 may provide details on user-managed tolerances to ensure billing data is successfully processed at both the market level and at the switch level.

According to the exemplary embodiments described herein, the data encapsulated by the reporting server 150 of the billing tool 110 may afford users with access to data in which they are truly authorized to view. Similar to the application server 130, the reporting server 150 may adjust the availability of specific reports according to a user's access level. Furthermore, the reporting server 150 of the billing tool 110 may save managers great deal of time and resources by reducing the amount of meetings and conferences that would otherwise be called to review and analyze the status of each billing cycle.

As noted above, the billing tool 110 may further include a notification server 160. The notification server 160 may send a notification (e.g., an e-mail alert) whenever any issue or task escalates to critical status. Examples for triggering a critical issue may include user-directed functions, such as, for example, pressing a button, entering a value of a field, entering system date, etc. Each of these “triggers” may activate an automated response (e.g., an associated action), such as, for example, automatically sending an e-mail message, automatically updating a field, performing a calculation, etc. Accordingly, an e-mail message may be automatically be generated and sent to specified personnel, such as managers, system administrator, executives, etc. The email message may also contain a hyperlink to a screen where the personnel can review the critical data and/or input new data.

According to the exemplary embodiments of the billing tool 110, the notification server 160 may notify time and system dependent events to a specified group via messaging service (e.g., any communication means, such as work groups, email, text message, pager notification, etc.). As processes within a bill cycle are classified as delayed, or in critical status, these notifications may be generated and transmitted. Notifications may include the date/time in which the process is expected to be completed, as well as the overdue time of the process. Furthermore, the notifying component may assist users with real-time fault management and alerts on critical issues and resources. Thus, the notification server 160 may serve as a internal messaging system for informing users of critical billing process failures and resolving these failures.

According to the exemplary embodiments of the system 100, and as noted throughout the above descriptions, the billing tool 110 may provide multiple cost savings to the business enterprise by automating manual work, centralizing billing process tracking information, providing a repository for issues to be resolved in a timely manner, and reducing the need for any additional resources. The billing tool 110 may be described as a system for providing a higher level of billing timeliness and accuracy.

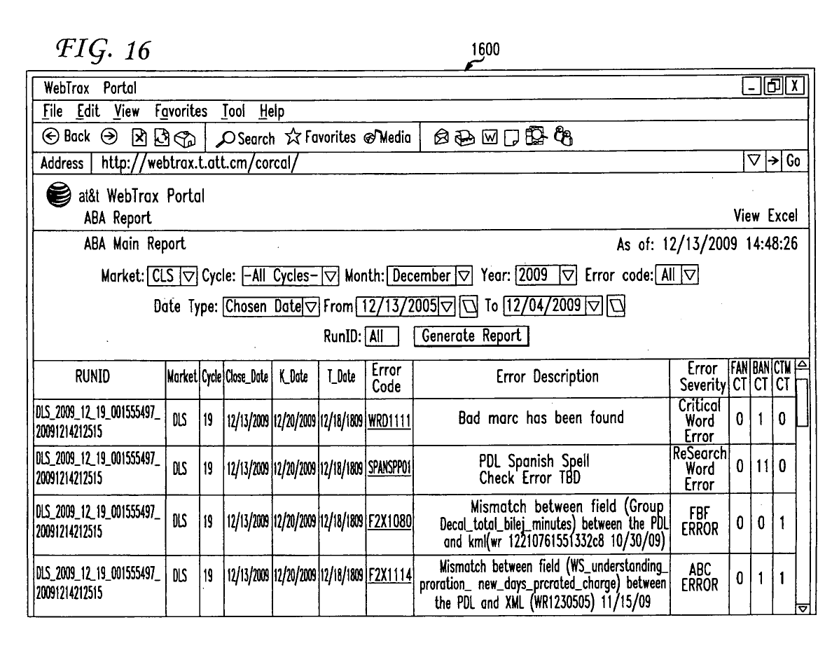

FIG. 16 shows an exemplary screen 1600 of automated bill audit (“ABA”) reporting on a GUI of the billing tool 110 according to an exemplary embodiment of the application. According to the exemplary embodiments of the billing tool 110, an ABA report may receive bill format details from an external engine, such as an ABA external engine. The bill format details may then be stored in the database 120 of the billing tool 110. Format errors may be presented, having “Error Codes” and “Error Descriptions” in the ABA reporting screen 1600. In other words, using a filtered form of the ABA reporting screen 1600, a Bill Quality Analyst may audit bill formats based on any number of factors (e.g., customer, market, cycle, month, year, etc.). The Bill Quality Analyst may then determine an impact to production or development any of these errors may create.

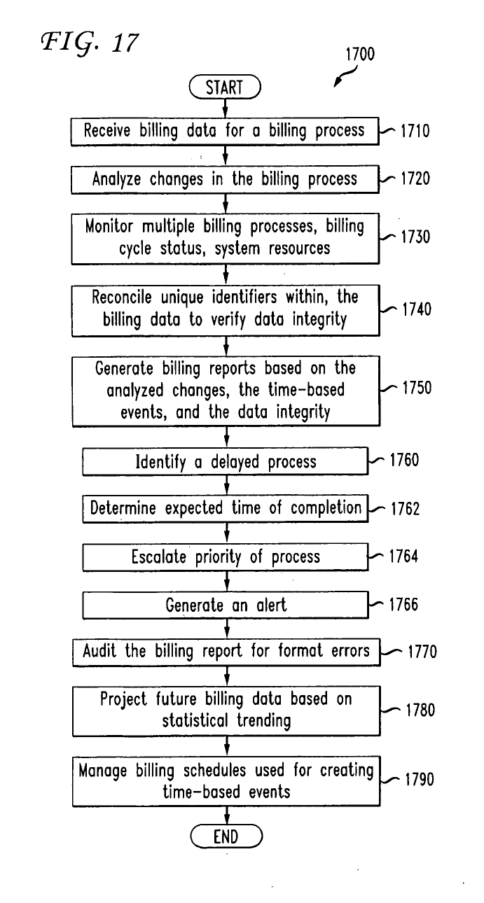

FIG. 17 shows an exemplary method 1700 for performing bill tracking and analysis across systems and departments. The method 1700 will be discussed with reference to billing tool 110 and components of the system 100 of FIG. 1. It should be noted that method 1700 is merely an exemplary embodiment of the steps and processes performed by the billing tool 110. Accordingly, any number of steps within the method 1700 may be repeated or omitted or performed in any sequence. In other words, the methods performable by the billing tool 110 are not limited to the number steps illustrated in FIG. 17, nor the order/arrangement of the steps illustrated in FIG. 17. Furthermore, it should be noted that the step described below may be stored on a computer readable storage medium, wherein the steps (or set of instructions) may be executable by a processor. For example, the steps may be executable via a single web interface available to a user.

Beginning with step 1710, the method 1700 may receive billing data from at least one billing process. According to one exemplary embodiment, step 1710 may be performed automatically by a rule-based engine.

In step 1720, the method 1700 may analyze changes in one or more billing processes. Specifically, in step 1720, the method 1700 may track any one of bill cycles, job statuses, billing issues, timeliness of the billing process, and/or accuracy of the billing process.

In step 1730, the method 1700 may monitor one or more billing processes for an occurrence of time-based events. Specifically, in step 1730, the method 1700 may perform real-time monitoring of any one of switch control queue processes, billing system resources, periodic status of jobs, data collection for fault management, and/or updates for bill reporting processes.

In step 1740, the method 1700 may reconcile unique identifiers within the billing data to verify data integrity. A usage assurance verification reporting, or the file reconciliation tool 170, may verify data integrity within the billing tool 110, thereby reducing and/or eliminating the risk of data loss.

In step 1750, the method 1700 may generate billing reports based on the changes and time-based events. Accordingly, these billing reports may facilitate the audit process for usage and revenue assurance organizations. For example, the method 1700 may provide a balance report audit tool for reporting daily switch-level of key metrics throughout a specific billing process. Switch control reports may provide users with real-time status updates of key switch provisioning database metrics in order to assist with proactive issue identification.

In step 1760, the method 1700 may identify at least one billing process as a delayed process. In step 1762, the method 1700 may determine an expected time of completion for the delayed process. Specifically, the method 1700 may allow for sufficient reaction time to correct issues prior to delaying any billing process. In step 1764, the method 1700 may escalate a priority of the delayed process until completion. In step 1766, the method 1700 may generate at least one of escalation alerts and notification alerts to responsible group via message.

In step 1770, the method 1700 may Audit the billing report for format errors. As noted above, an automated bill audit (“ABA”) report may receive bill format details from an external engine, such as an ABA external engine. A Bill Quality Analyst may utilize a filtered form of the ABA report to audit bill formats based on any number of factors (e.g., customer, market, cycle, month, year, etc.). The Bill Quality Analyst may then determine an impact to production or development any of these errors may create.

In step 1780, the method 1700 may project future billing data based on statistical trending. Specifically, the method 1700 may perform revenue analysis trending calculations (e.g., projecting trends in billing cycle revenue data). These calculations may allow an auditing team to manage tolerances and validate revenue fluctuations.

In step 1790, the method 1700 may manage billing schedules used for the time-based events. Specifically, the method 1700 may calculate event milestone dates based on the managed billing schedules.

It will be apparent to those skilled in the art that various modifications may be made in the described embodiments, without departing from the spirit or the scope of the application. Thus, it is intended that the present disclosure covers modifications and variations of this application provided they come within the scope of the appended claimed and their equivalents.

What is claimed is:

1. A computer readable storage medium including a set of instructions that are executable by a processor, the set of instructions being operable to:
receive billing data from at least one billing process;
analyze changes in the at least one billing process;
monitor the at least one billing process for an occurrence of time-based events;
reconcile unique identifiers within the billing data to verify data integrity;
generate a billing report based on the changes, the time-based events and data integrity; and
audit the billing report for format errors.

2. The computer readable storage medium according to claim 1, wherein the set of instructions are further operable to:
authenticate a user entering billing data; and
provide the user with process-specific access to the at least one billing process based on a clearance level.

3. The computer readable storage medium according to claim 1, wherein the set of instructions are executable via a single web interface.

4. The computer readable storage medium according to claim 1, wherein the set of instructions are further operable to:
identify at least one billing process as a delayed process;
determine an expected time of completion for the delayed process; and
escalate a priority of the delayed process until completion.

5. The computer readable storage medium according to claim 1, wherein the set of instructions are further operable to:
generate at least one of escalation alerts and notification alerts to a specified group via a messaging service.

6. The computer readable storage medium according to claim 1, wherein the set of instructions are further operable to:
project future billing data based on statistical trending.

7. The computer readable storage medium according to claim 1, wherein the set of instructions are further operable to:
manage billing schedules used for the time-based events.

8. The computer readable storage medium according to claim 1, wherein the receiving of the billing data is performed automatically by a rule-based engine.

9. The computer readable storage medium according to claim 1, wherein the analyzed changes in the at least one billing process includes tracking at least one of bill cycles, job statuses, billing issues, timeliness of the billing process, and accuracy of the billing process.

10. The computer readable storage medium according to claim 1, wherein the monitoring of the at least one billing process further includes real-time monitoring of at least one of switch control queue processes, billing system resources, periodic status of jobs, data collection for fault management, and updates for bill reporting processes.

11. A system, comprising:
a receiving means receiving billing data from at least one billing process;
an analyzing means analyzing changes in the at least one billing process;
a monitoring means monitoring the at least one billing process for an occurrence of time-based events;
a reconciling means reconciling unique identifiers within the billing data to verify data integrity;
a report generating means generating a billing report based on the changes, the time-based events and data integrity; and
an auditing means auditing the billing report for format errors.

12. The system according to claim 11, further comprising:
an authentication means authenticating a user entering billing data; and
an access-provisioning means providing the user with process-specific access to the at least one billing process based on a clearance level of the user.

13. The system according to claim 11, wherein the system provides a single web interface to a user.

14. The system according to claim 11, further comprising:
an identifying means identifying at least one billing process as a delayed process;
a determining means determining an expected time of completion for the delayed process; and
an escalating means escalating a priority of the delayed process until completion.

15. The system according to claim 11, further comprising:
an alert generating means generating at least one of escalation alerts and notification alerts to a specified group via a messaging service.

16. The system according to claim 11, further comprising:
a projecting means projecting future billing data based on statistical trending.

17. The system according to claim 11, further comprising:
a managing means managing billing schedules used for the time-based events.

18. The system according to claim 11, wherein the receiving means is an automated rule-based engine.

19. The system according to claim 11, wherein the analyzed changes in the billing process includes changes in at least one of bill cycles, job statuses, billing issues, timeliness of the billing process, and accuracy of the billing process.

20. The system according to claim 11, wherein the monitoring means monitors at least one of switch control queue processes, billing system resources, periodic status of jobs, data collection for fault management, and updates for bill reporting processes.
